(19) United States
(12) Patent Application Publication
(10) Pub. No.: US 2009/0204465 A1
(43) Pub. Date: Aug. 13, 2009

(54) Process and system for facilitating communication and intergrating communication with the project management activities in a collaborative environment

(76) Inventor: Santosh Pradhan, Tallahassee, FL (US)

Correspondence Address: Pennington, Moore, Wilkinson, Bell & Dunbar, P.A., Post Office Box 10095, Tallahassee, FL, 32302-2095, US

(21) Appl. No.: 12/069,330

(22) Filed: Feb. 8, 2008

(51) Int. Cl. G06Q 10/00; G06Q 90/00

(52) U.S. Cl. 705/9; 705/8

(57) ABSTRACT

The computer-enabled system and method is provided to digitally capture communication related to a project and analyze the captured communication to create and manage work items of the project in a collaborative environment. The invention can be used annotate portions of a digitally captured communication that relate to a potential work item for the project, thereby simultaneously generating a work item and initiating a workflow for the work item. The system may further configured to automatically generate tasks to insert into the user's work breakdown structure when the work items are generated.

### CROSS-REFERENCES TO RELATED APPLICATIONS

Not Applicable.

### STATEMENT REGARDING FEDERALLY SPONSORED RESEARCH OR DEVELOPMENT

Not Applicable.

### MICROFICHE APPENDIX

Not Applicable

### BACKGROUND OF THE INVENTION

1. Field of the Invention

This invention relates generally to the field of communication and project management. More particularly, the present invention comprises methods and systems for consolidation or integration of communication and to create and track work items for a project using digitally captured communications and integrating communication with the project management activities.

2. Description of the Related Art

Project management requires a great deal of communication among the members of a project team. A project is broken down to work items or tasks or activities level for making it easier to manage. When team member communicate with each other on a topic related to a project then often it is a task or an activity they are working on. This is particularly true in the field of Information Technology (“IT”). Throughout the execution of an IT project, information is passed from one team member to another team member using various formal and informal modes of communication. Formal communications may include planned meetings and written project reports. Informal communications may include hallway conversations, phone conversations, e-mails, online forums video conferences, online video conferences (webinars) and/or online chat conversations. A communication always relates to a project and particularly to a work item of a project.

Managing an IT project involves keeping track of various work items, e.g. “Milestones,” “Deliverables,” “Open Items,” “Action Items,” “Risks,” “Issues,” “Requirements,” “Change Orders,” “Use Cases,” “Test Cases,” “Releases,” and other custom defined work items. These work items conventionally originate from communications between the members of the project team or between a member of the project team and a client. Thus, a particular work item may originate from a meeting, an email, a report, a conversation, or a thread on an online forum.

Large projects may involve participation from team members in remote locations. Recent technological advancement facilitates participation of team members from remote locations, allowing them to communicate via e-mails, personal online chat, online forum, phone calls, etc. However, their project related communication typically takes place outside the “project domain”. Team members use their own communication tools not integrated with the project portal. As a result, the ability to trace and review communication histories is often lost. Over a period of time team members may change or communication gets deleted and traceability or references to the communication is lost or other team member not party to the communication never gets to see what is being communicated related to the project or a work item of a project.

Typical IT project teams vary in size from 5 members on small projects to as many as 100 or more members on large projects. “Subject Matter Experts” provide business knowledge in Joint Application Development (JAD) meetings. “Business Analysts” capture the business knowledge and produce various project related documents. The documents are circulated amongst the project team members for review and feedback. These documents are passed on to “Developers” who write software application code to produce the end product. Many consulting companies have their development centers off-shore and Developers never see Subject Matter Experts face-to-face. Often, instructions are distorted when they are passed from one team member to another. This can result in the misinterpretation of requirements give by Stakeholders or Subject Matter Experts about the product to be developed. As a result, the end product produced may not deliver the expected functionality. Thus it would be desirable to provide a communication product that digitally captures communication under a project portal, organizes it, and references it to a particular project and work item to improve communication, store it under a project portal for historical or tracking purpose, and reducing distortion in passing information from one hand to another.

Furthermore, projects involve various participants performing separate duties on a project to accomplish the common goal of project completion. A release of a software application involves the coordination of many participants and project resources. Therefore there is a need to have controlled workflow implementation in the system for various participants to perform certain activities based on their roles on a project. For example, various team members can propose a new requirement but implementing a requirement has monetary impact on a project. Thus, it is often required for a Sponsor or Project Manager to “approve” the implementation of Requirement. Once the requirement is approved, it takes Developers and other resources to work on implementing the expected functionality. When the code is written, it gets tested by “Testers” and finally it gets implemented in a Release. Possibly, many communication threads take place when the Requirement is passed through the workflow.

There are many tools available in the market that track work items and implement workflow management but none of the tools integrate communication with workflows or project plan. Thus, there exists a need in the art for a method and system for collaborative project management which captures project related communication under the project portal, automatically creates work items from the digitally captured communication, and applies the work items to the project workflow to allow various participants to perform activities in a controlled environment, and organize the communication around work items.

### BRIEF SUMMARY OF THE PRESENT INVENTION

The present invention generally comprises a computer-implemented method and system for coordinating a project to be executed by a project team. The method includes capturing all types of communication in one single repository using computer storage, and generating specific project management related work items using text annotation and attribution functions, and organizing communication in more meaningful manner. These work items may then be inserted into a work breakdown structure. The captured communications can be easily retrieved by members of the project team to utilizing the communications referenced association with a particular work item.

It is envisioned that such a communication capturing and annotating process may support various modes of formal or informal communication including but not limited to: capturing and distribution of meeting notes or other project related documentation, e-mail correspondences, Peer-to-Peer online chat conversations, online “forum” discussions, notes or summaries from phone or “hallway” conversations, audio recording of meetings, video conference, voice over IP (VoIP) Phone calls or integrated telecommunication or online video chats. When such a communication affects a project requirement or otherwise requires a work item, the communication, already being captured on the system can be annotated and referenced to a specific work item, thereby generating the work item in a workflow and work breakdown structure and making a permanent association of the communication so annotated with the work item generated.

In one example, the system may be used in the IT field as part of Joint Application Development (JAD) meetings. The system may be used to prepare and circulate meeting agenda among the participants, to schedule and perform meetings to discuss project related matter, to capture meeting notes during the JAD meeting, to distribute and review minutes of meeting, to collect feedback on the meeting and follow-up correspondences.

The method further includes capturing discrete portion of information within a project related communication in digital format and attributes may be assigned to portions of the text to create work items, tasks or activities, such as: Milestones, list of Deliverables, Agenda Items, Action Items, Open Items, Issues, Risks, Requirements, Change Orders, Release Management, Use Case management, Test Scripts, Test Results, or any such custom specified items.

In the preferred embodiment, the method further includes providing secured access to the work items and allow users to perform actions or activities based on their roles for a specific project. Thus, a system employing the present invention may capture and maintain project records for an organization, and grant or deny access rights to users based on the user's roles. In one example, a user acting as a Business Analyst can capture meeting notes (as “Draft” version) during the meeting but is restricted from “approving” the meeting notes. In this example, meeting notes may only be approved (as “Final” version) by a Project Manager or a Subject Matter Expert.

In the preferred embodiment, the method further includes managing a user's access rights in multi-project environment, meaning assigning one user to one or more projects in each different capacity. One user may perform one role on one project, and another role on different project. For example, a user may be a Business Analyst on one project and a Project Manager on another project. Hence, it is possible that a user performs different roles on different projects. Using the present invention, access rights and other permissions may defined by both the user and the project.

In the preferred embodiment, the method further includes assigning specific workflows to every work item. For example, a Requirement work item may follow the workflow sequence—Proposed, Approved for Implementation, Development Complete, Tested, and Implemented. Each step of this sequence may be considered a “state.” The present invention may track each work item as it changes states. The reader should therefore appreciate that every work item can follow predefined workflow paths. The method further implements a process for customizing the workflows based on the need of different projects.

In the preferred embodiment, the method further includes designating various user roles such as: Project Manager, Business Analyst, Subject Matter Experts, Stakeholders, Project Owner, Developer, Tester and other custom defined roles. The method further includes creating user accounts, assigning user identification, password and assigning roles. As mentioned previously, each of these roles may have predefined access rights and may be restricted or granted access rights based on the role.

An embodiment of a system for generating and organizing information in a collaborative environment is disclosed. The system may include an input device and a processor in a communication with the input device and configuration to execute a computer program. The system may further be configured for receiving discrete portions of information using the input device and formatting each of the discrete portions of information as in output, wherein each output includes a visually perceptible version of each discrete portion of the information and a computer readable symbology of each discrete portion of the information.

Another embodiment of a system for generating and organizing information in a meeting is disclosed. The embodiment includes a computer network, Internet access, individual desktop PCs connected via Internet, tablet PC, or handheld devices such as cell phones, Personal Digital Assistance (PDA), VoIP Phones, Telecommunication Phones, video conferencing equipments, a printer or printers in communication with the computer network and a plurality of computers or other input devices, in communication with each other. Each of the plurality of computers may be configured for receiving information and generating an output comprising the information and a computer readable symbology of the information according to the embodiment.

Computer media for storing a computer program implementing embodiments of a method of the present invention are also described. Additional features and advantages of the invention will be apparent from the detailed description which follows, taken in conjunction with the accompanying drawings, which together illustrate, by way of example, features of embodiments of the present invention.

### BRIEF DESCRIPTION OF THE SEVERAL VIEWS OF THE DRAWINGS

The above-mentioned and other features and advantages of the present invention will be better understood based the following details description of the invention with reference to an accompanying drawing, in which:

FIG. 1 is a functional block diagram illustrating system architecture for facilitating project related communication and managing information technology projects in collaborative environment according to one or more embodiments of the present invention.

FIG. 2 is a user interface illustrating the addition of a new project to the database according to one or more embodiments of the present invention.

FIG. 3A is a user interface illustrating how project milestones and deliverables may be defined according to one or more embodiments of the present invention.

FIG. 3B is a user interface illustrating how a portion of the text may be selected with a Project Milestone/Deliverables text box according to one or more embodiments of the present invention.

FIG. 3C is a user interface illustrating how the present invention may be used to identify milestones for a project according to one or more embodiments of the present invention.

FIG. 3D is a user interface illustrating how the present invention may be used to identify specific project Deliverables and add them in the database as separate Milestones and Deliverables according to one or more embodiments of the present invention.

FIG. 4A is a user interface illustrating how the present invention may be used to assign or grant user access rights to the system in a multi-user environment according to one or more embodiments of the present invention.

FIG. 4B is a user interface illustrating how the present invention may be used to grant rights to the user for one or more projects in the system when the user has different roles on different projects according to one or more embodiments of the present invention.

FIG. 5A is a user interface illustrating how the present invention may be used to schedule one or more meetings for a project and prepare agenda for the meetings according to one or more embodiments of the present invention.

FIG. 5B is a user interface illustrating how the present invention may be used to invite one or more participants to a meeting according to one or more embodiments of the present invention.

FIG. 6 is a user interface illustrating how the present invention may be used to select a portion of a text, identify it as a specific work item and insert the work item into the database according to one or more embodiments of the present invention.

FIG. 7 is a user interface illustrating a summary of the communication activity and state change history of a selected work item according to one or more embodiments of the present invention.

FIG. 8A is a user interface illustrating how the present invention may be used to send communications which reference a selected project and work item and according to one or more embodiments of the present invention.

FIG. 8B is a user interface illustrating a summary of all e-mail communication that has taken place with reference to a selected project and work item according to one or more embodiments of the present invention.

FIG. 9A is a user interface illustrating an online forum post with reference to a selected project and work item according to one or more embodiments of the present invention.

FIG. 9B is a user interface illustrating a summary of all forum posts that has taken place with reference to a selected project and selected work item according to one or more embodiments of the present invention.

FIG. 9C is a user interface illustrating how the present invention may be used to view a selected forum post, thereby facilitating another user to read the post and reply to the post with reference to the selected project and work item according to one or more embodiments of the present invention.

FIG. 10 is a user interface illustrating how the present invention may be used to capture an online chat conversation that takes place in the context of a selected project and work item according to one or more embodiments of the present invention.

FIG. 11A is a user interface illustrating how the present invention may be used to capture a small talk conversation in a text format according to one or more embodiments of the present invention.

FIG. 11B is a user interface illustrating how the present invention may be used to capture a small talk conversation that is saved in an external file according to one or more embodiments of the present invention.

FIG. 11C is a user interface illustrating how the present invention may be used to capture a small talk conversation that is saved externally in a flash media file according to one or more embodiments of the present invention.

FIG. 11D is a user interface illustrating how the present invention may be used to capture a small talk conversation that is saved externally in a window's media file according to one or more embodiments of the present invention.

FIG. 12 is a menu option of a user interface illustrating how the present invention may be used to integrate various work item management workflows in the system.

FIG. 13 is a menu option of a user interface illustrating how the present invention may be used to record and integrate various communications channels in a digital format storing in the database of the same integrated processes or methods of the current invention.

FIG. 14 is a menu option of a user interface illustrating how the present invention may be used to record and integrate external documents with reference to one or more projects and one or more work items and store the documents electronically in a database.

FIG. 15 is a menu option of a user interface illustrating integrating project management related processes and methods as part of the present integrated invention.

FIG. 16 is a user interface illustrating how the present invention may be used to upload a file with reference to a project and selected project work item.

FIG. 17 is a user interface illustrating how the present invention may be used to “Accept” a “Proposed” work item and insert the work item in the database as “New” thereby starting the workflow of the work item.

FIG. 18 is a block diagram of a Requirement Management workflow, illustrating the life cycle of a requirement in an integrated processes and methods of the present invention.

FIG. 19 is a block diagram of a Change Order Management workflow, illustrating the life cycle of a Change Order in an integrated processes and methods of the present invention.

FIG. 20 is a block diagram of an Issue Management workflow, illustrating the life cycle of an Issue in an integrated processes and methods of the present invention.

FIG. 21 is a block diagram of a Risk Management workflow, illustrating the life cycle of a Risk in an integrated processes and methods of the present invention.

FIG. 22 is a block diagram of an Open Item Management workflow, illustrating the life cycle of an Open Item in an integrated processes and methods of the present invention.

FIG. 23 is a block diagram of an Action Item Management workflow, illustrating the life cycle of an Action Item in an integrated processes and method of the present invention.

FIG. 24 is a block diagram illustrating automation of generating Tasks under the Work Breakdown Structure of a project plan using work items created from captured communications.

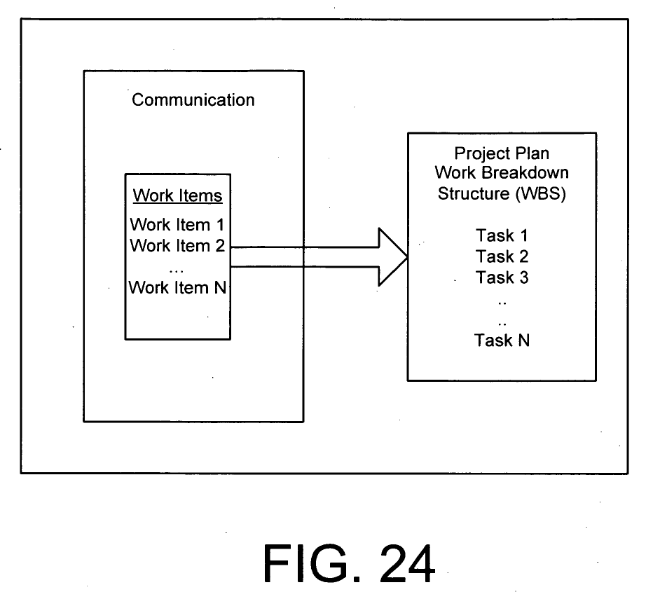

### DETAILED DESCRIPTION OF THE INVENTION

The following detailed description includes many specific details. The inclusion of such details is for the purpose or illustration only and should not be understood to limit the invention. Throughout this discussion, similar elements are referred to by similar number in the various figures, for ease of reference. It should be noted that features in one embodiment may be combined with features in other embodiments of the invention.

The present invention is generally useful for (1) facilitating communication with reference to a project and/or work items; (2) integrating digitally captured communication with the generation and tracking of work items, (3) facilitating project management activities; (4) tracing work items using workflows; (5) electronically generating and distributing various project related documentation; (6) facilitating and capturing user feedback; and (7) managing the role based user security all within a collaborative environment. The collaborative environment discussed herein may be presented to end user via a web site over the World Wide Web (i.e. the Internet) and/or a locally executed software application with underlying database and interfacing with other mentioned devices (such as phones, video conferencing, PDA, etc.). For ease of description, such a collection of information and communication will be referred to herein as “database”, although it should be recognized that the information might be collected in other formats as well, and that a communication media or documentation might not be restricted to data stored in a database.

The present invention will be described in the context of a project management application. More particularly, the present invention will be described in the context of a project management application in the Information Technology (“IT”) field. The invention may be used in many other applications, however.

Project managers, particularly in the IT field, are concerned with the execution of various “work items” including action items, open items, requirements, change orders, milestones, deliverables, issues, risks, use cases, test scripts, and test results. Although these terms are readily understood by those that are skilled in the art, a brief description of the various work items may assist the reader in appreciating the utility of the present invention.

“Action items” are discussion items that need further investigation before a decision can be made. Action items typically arise during a meeting, and a project manager will commonly assign one or more team members with the responsibility of investigating the item further and reporting on the findings of the investigation in a following meeting so that a decision can be made at that time.

“Open items” are discussion items which are listed on a meeting agenda, but are not resolved during a meeting—usually because of a time limitation. A project manager may wish it present these open items in a later team meeting so that the item can be discussed by the members of the team and resolved.

“Requirements” are conditions or capabilities that must be met or possessed by a by a system, product, service, result, or component to satisfy a contract, standard, specification or other formally imposed documents. Requirements include the quantified and documented needs, wants, and expectations of the sponsor, customer, and other stakeholders. In the context of an IT project, a requirement discretely describes a functionality that can be independently implanted, tracked and measured.

“Change Orders” specify the functional changes needed to be implemented with reference to an earlier version of a system, product, service, result, or component.

“Milestones” define the functionalities of one or more requirements and/or one or more change orders that can be grouped together and implemented by a specified date. Project performance is often tracked based on the achievement of milestones.

“Deliverables” are artifacts that convey the “customer certain” completion of work. In many cases, deliverables describe milestones. In the IT field, examples of such artifacts include Project plans, Software Requirement Specification (SRS) documents, Vision documents, Project Charter documents, Test Cases, Test Results, or Software Code.

“Issues” are matters in question or in dispute or a matter that is otherwise not settled. Issues typically involve opposing views or disagreements between members of the project team or between a member of the project team and client.

“Risks” are uncertainties or conditions that, if occur, are likely to have a positive or negative effect on a project's objectives.

“Releases” are software applications capable of delivering a set of functionality as described in one or more requirements and/or one or more change orders on top of the base line software or earlier release. Typically, consecutive releases are assigned numbers in increment and all work performed on a project is tracked with reference to releases.

“Use Cases” are documents that describe business process and its set by step flow and its one or more business scenarios that can occur under multiple possible conditions.

“Test Scripts” are documents that outline the process flow of an application on a step-by-step basis and describe the expected results from the system at each step.

“Test Results” are the results recorded by a Tester when the Tester executes the test scripts. The recorded results are compared with the conditions stated in the test script to determine that the application operates as scripted.

Various project management methodologies are employed by project managers and project teams in the execution of work items. These methodologies define the performance of a project work item in terms of a step-by-step process with control mechanisms that are integrated to insure effective and efficient execution of work items. Project managers typically employ a Work Breakdown Structure (“WBS”) as a project management technique to define and organize the total scope of a project using a hierarchal tree structure of the work to be executed. Thus a WBS of a project consists of a deliverable-oriented hierarchical decomposition of the work to be executed by the project team to accomplish the project objectives and create the required deliverables. It organizes and defines the total scope of the project. Each descending level represents and increasingly detailed definition of the project work.

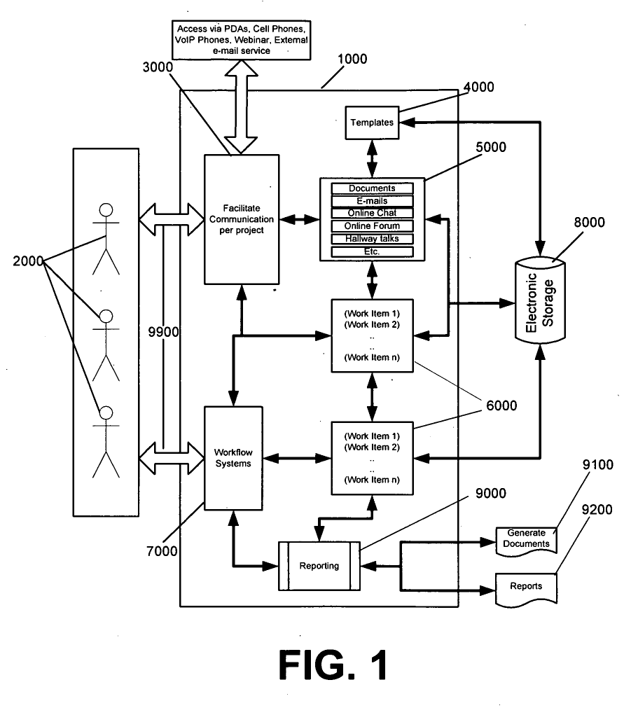

FIG. 1 is a functional block diagram illustrating a system architecture for a system capable of carrying out the method of the present invention. In the illustrated example, the system is realized as integrated communication and project management portal 1000 on a general purpose computer, communicating with a network (e.g. the Internet) through communication pathway 9900. The system provides method for facilitating communication 3000 for various users 2000 performing various roles. The system facilitates communication via various communications 5000. Predefined or custom-defined templates 4000 can be used during the communication. The system also implements predefined or custom-defined workflows 7000 for managing work items 6000. Work items 6000 can move or change state according to predefined workflows 7000. Electronic storage 8000 (such as a database) is used to store digitally captured communications 5000 and work items 6000. Reporting functions 9000 are implemented to generate Documents 9100 and generate various Reports 9200.

According to one or more embodiments of the present invention, the communication between users may electronically be stored in its original format. Alternately, it may be reformatted at some point or points prior to storage or reproduction. The various format of communication include documents, e-mails, online chat, online forum, phone conversations, video conferences, webinars, hallway talks, and etc. These formats may collectively be referred to throughout the present disclosure as “communications.”

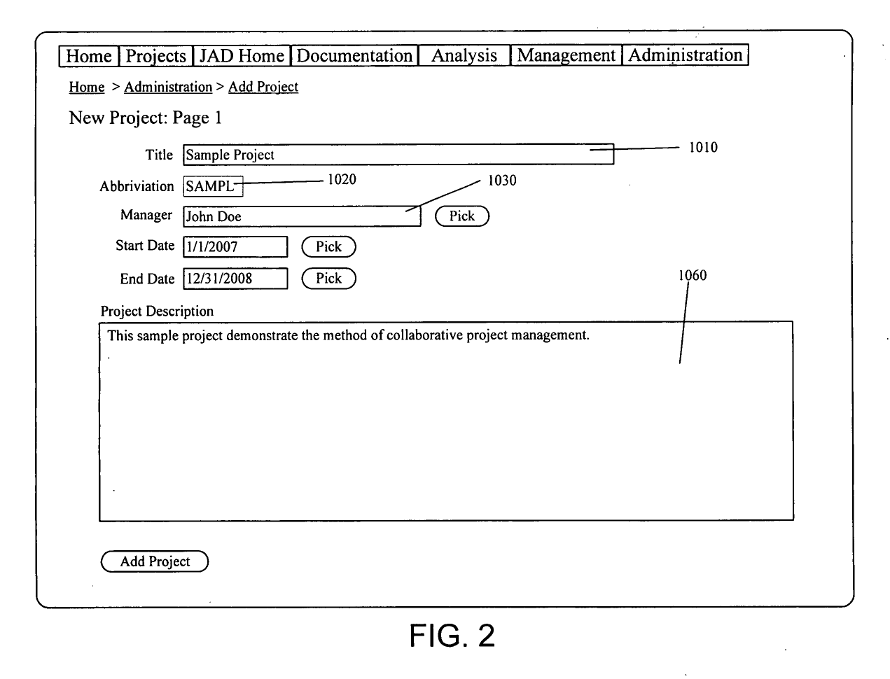

According to the illustrated example, communication and project management takes place with reference to a specific project. All communication items are organized under the project portal. Therefore the first step is to create the project record in electronic storage 8000. Referring now to FIG. 2, a sample user interface is illustrated to depict the creation of a new project record in the system. Basic information regarding the project is provided on this screen. Project Title 1010, Project Abbreviation 1020, Project Manager 1030 and Project Description 1060 are captured on the Add Project screen. This information is then stored in electronic storage 8000.

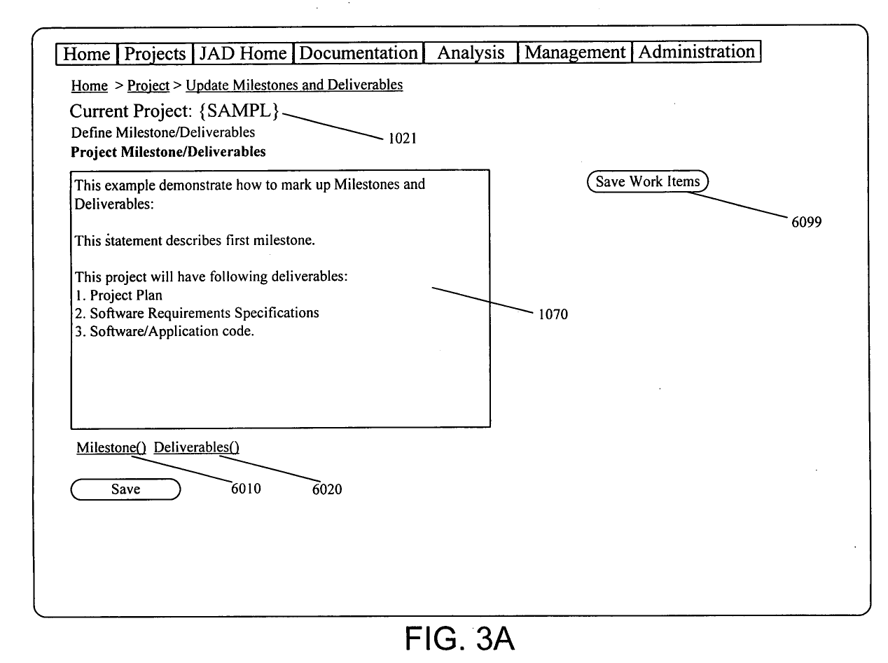

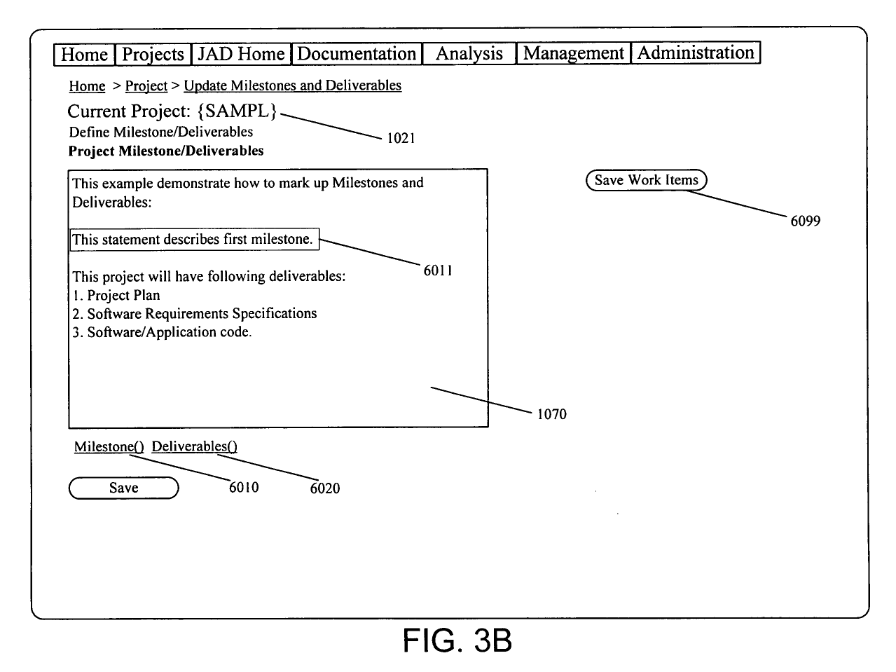

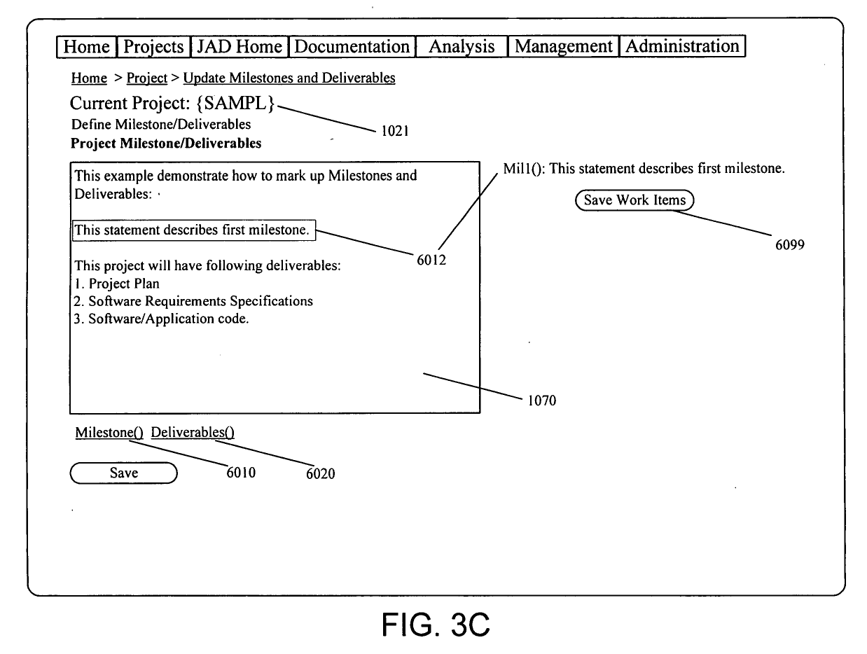

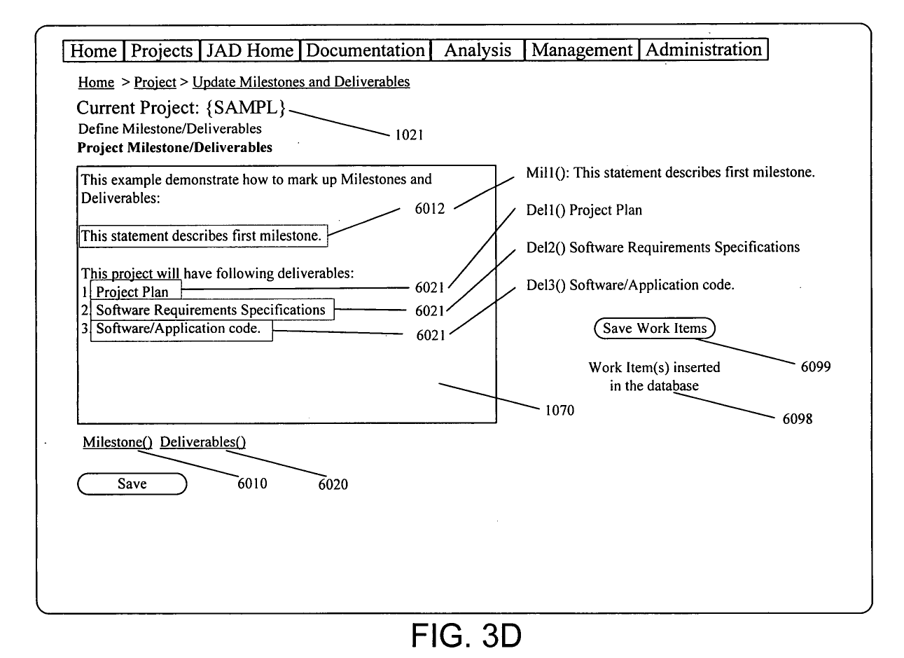

FIGS. 3A-3D illustrate steps involved in capturing project definitions and creating records of Milestones and Deliverables from the project definition text. FIG. 3A shows the user interface screen for capturing the description about project's Milestones and Deliverables. Project abbreviation 1021 identifies the project for which the Milestones and Deliverables pertain. The user inputs the details for the selected project in text area 1070.

As shown in FIG. 3B, the user can select portion 6011 of the entered text (using a mouse or other selection means) and then select Milestone( ) 6010 to automatically initiate the creation of Milestone 6012 in the system. Turning to FIG. 3C, this work item is added above Save Work Items button 6099 to indicate that a work item has been provisionally created. The user can also select multiple Deliverables from the text area by highlighting text and selecting Deliverable( ) 6020. Turning to FIG. 3D, the reader will note that three different entries for Deliverables 6021 have been provisionally created (one entry corresponding to each line of text). The user clicks the Save Work Items button 6099 button to insert the selected Milestone and Deliverables as work items in the database. The system displays message 6098 to confirm that the entries have been added in the database. Selected text from the project definition document may also be highlighted with a given color scheme. This annotation method allows the work item to be traced to its origins in the project definition document if referenced in the future.

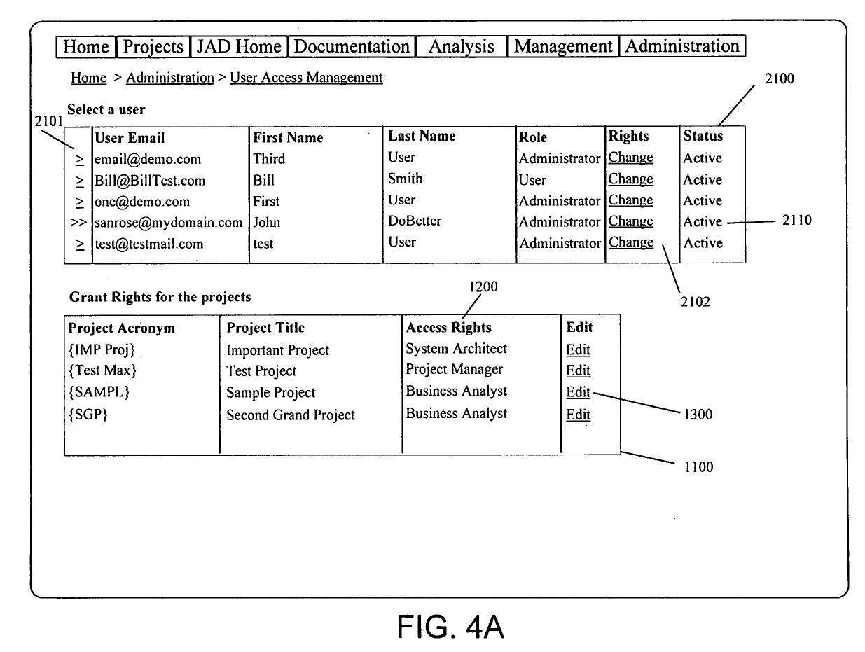

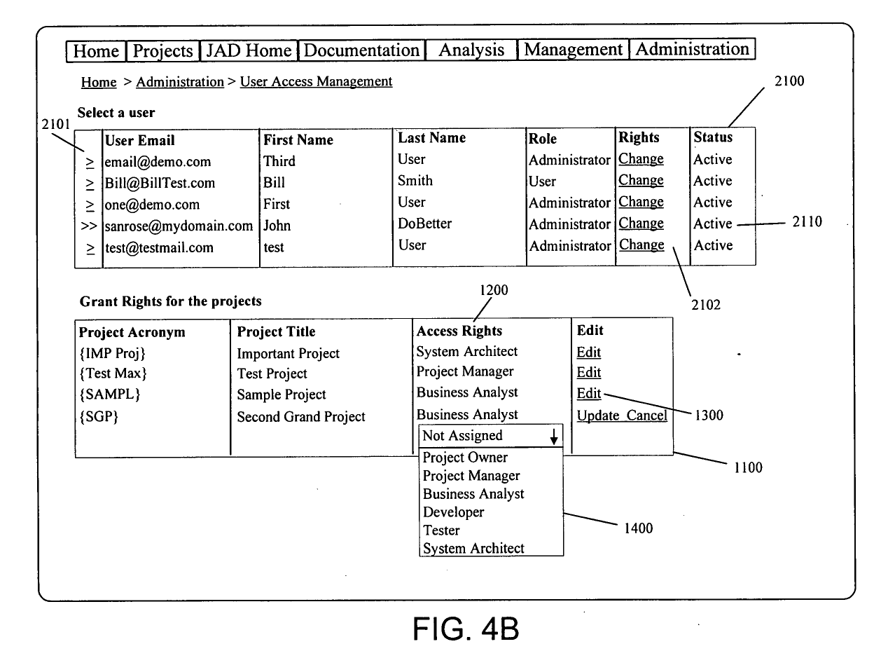

FIGS. 4A and 4B illustrate a User Access Management screen. This interface shows the roles of various users and the assignments of each user for each project. This is particularly useful for project teams that work in a multi-project environment. User grid 2100 lists all users that have access to the project portal. User record 2110 has been selected by clicking “Select” link 2101 on an individual record and in next step by clicking the “Change” link 2102 button from the “Status” column. Project grid 1100 lists all projects the selected user is involved with and the selected access rights 1200 per project. A user can click “Edit” link 1300 to change a team member's access rights. FIG. 4B shows dropdown list 1400 which contains an assortment of predefined roles. In the preferred embodiment, these roles can be altered or more roles can be created for further customization.

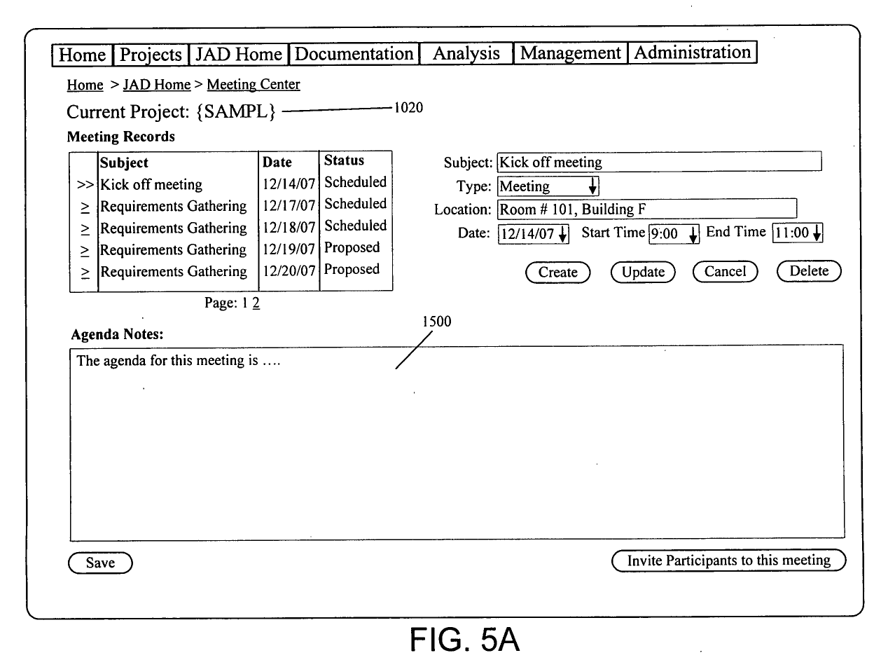

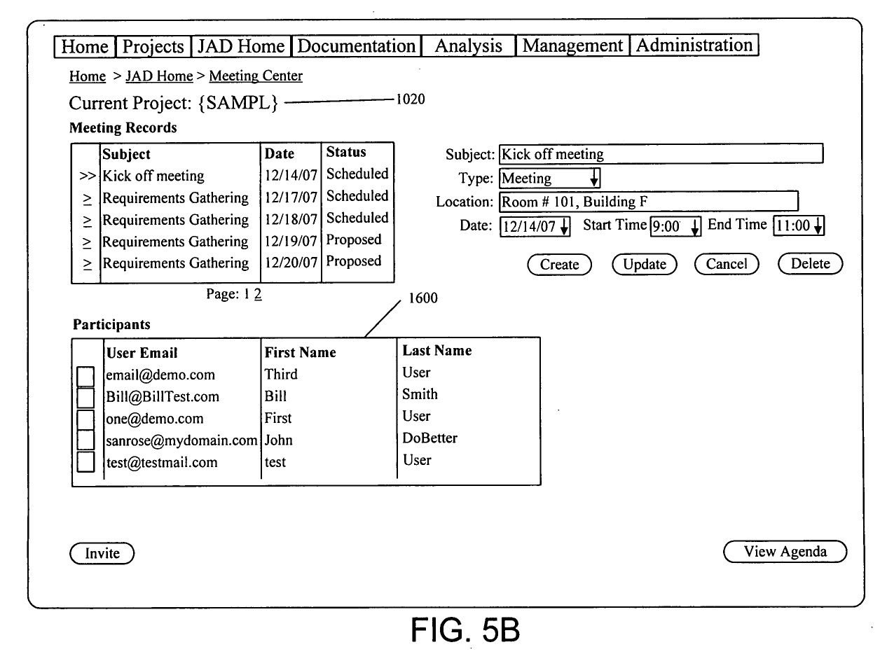

An interface for scheduling meetings is illustrated in FIGS. 5A and 5B. Project abbreviation 1020 indicates the project for which the scheduled meeting pertains. Text box 1500 is provided for inputting information such as the meeting agenda. Turning to FIG. 5B, the interface may also be used to select members of the project team who are to receive the meeting invitation. Since the members associated with each project are referenced in the electronic storage of the system, the interface displays each of the members that are involved with the project in invitation selection box 1600. A simple look-up function may be employed using project abbreviation 1500 to retrieve the list of members associated with the project. The meeting records will be created and stored in the electronic storage 8000 and invited users will be notified about the scheduled meeting.

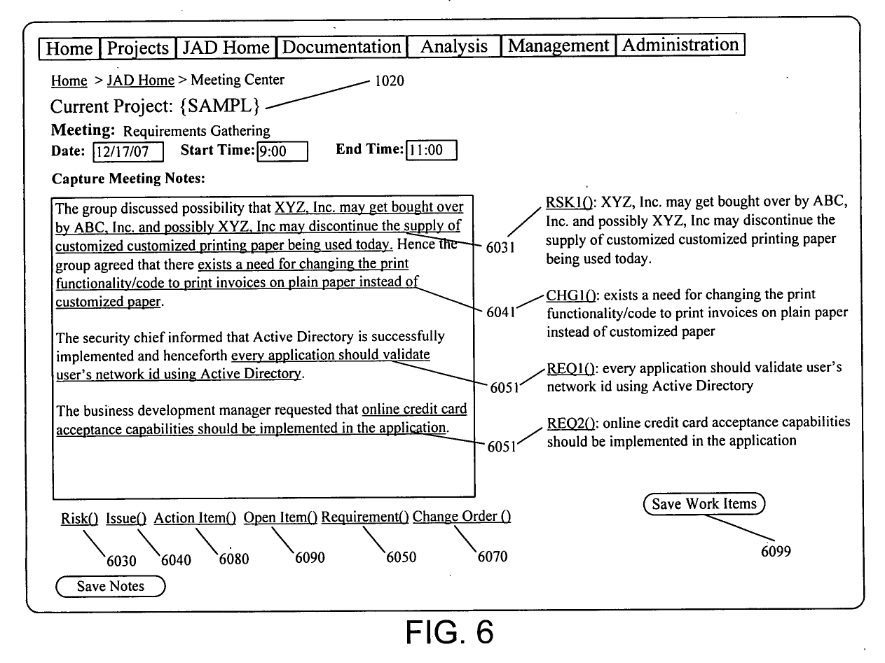

FIG. 6 illustrates how the system may be used to capture meeting minutes. During the meeting a scribe or Business Analyst can input discussions of the group in plain text format in text area 1700 provided in the interface shown in FIG. 6. During or after the meeting, the system may be used to annotate the meeting minutes. In FIG. 6, several of such annotations are illustrated including one Risk record 6031, one Change Order record 6041, and two Requirement records 6051. Each annotation record indicates a separate work item to be created. Various annotation methods may be used. In the present example, a portion of the text corresponding to a desired work item is highlighted with a cursor. The user then may select one of Risk( ) annotation tool 6030, Issue( ) annotation tool 6040, Action Item( ) annotation tool 6080, Open Item( ) annotation tool 6090, Requirement( ) annotation tool 6050 or Change Order( ) annotation tool 6070 to specify what type of work item is to be created. Color or alphanumeric annotations may be placed on or around the selected text in the originating document to indicate that a work item generated from the selected portion of text within the document. This allows the user to quickly review a document and discern which portion of a document relates to a created work item when the user is engaged in a project task relating to the work item at a later time.

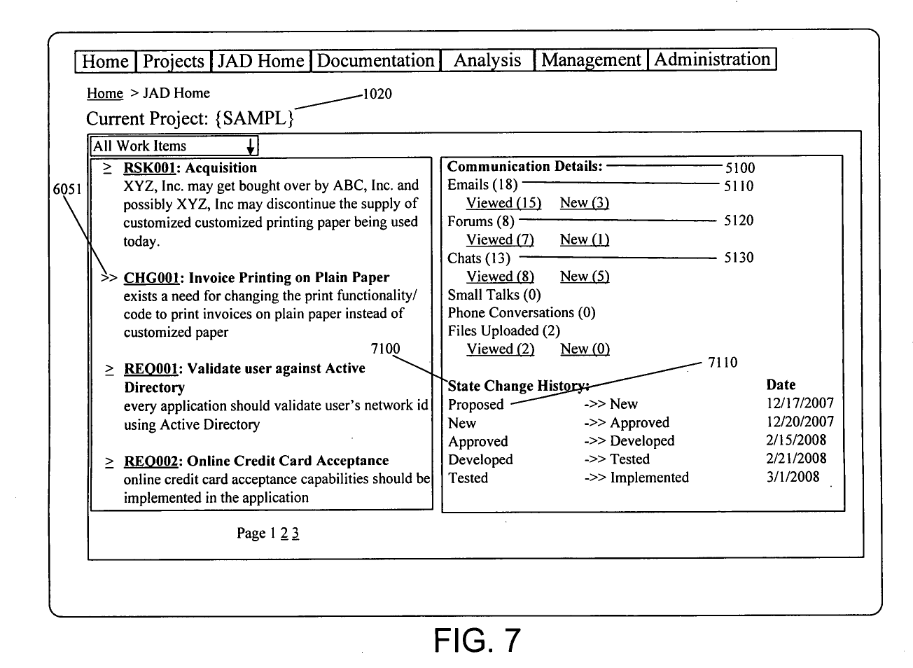

In addition, as shown in FIG. 7, the system may be used to sort all communications between members of the team which reference a selected project and work item. On the left side of the interface, all work items relating to the project referenced as project abbreviation 1020 are listed. Communication detail summary 5100 and state change history 7100 are shown on the right side of the interface. Communication detail summary 5100 and state change history 7100 provide a summary view of all communication and events that have occurred in the integrated system for the project referenced as project abbreviation 1020 and selected work item 6051. In the present example, Project SAMPL is selected and work item REQ001 is selected. For this selection, Communication Details 5100 and State Change History 7100 are shown. As shown on the summarized screen, for the selected work item, 18 E-mail communications 5110 have taken place, 8 Forum posts 5120 have been made, and 12 Chat conversations 5130 have taken place. State Change History 7100 shows how the state of REQ001 6051 has changed historically.

As mentioned previously, traceability of all state change history is maintained in the system. By clicking on the “Proposed” State 7110, the system will navigate to the originating document where the work item was “proposed.” The originating document may appear like the interface shown in FIG. 6 with annotations provided on the communication indicating which portion or portions of the document reference the work item.

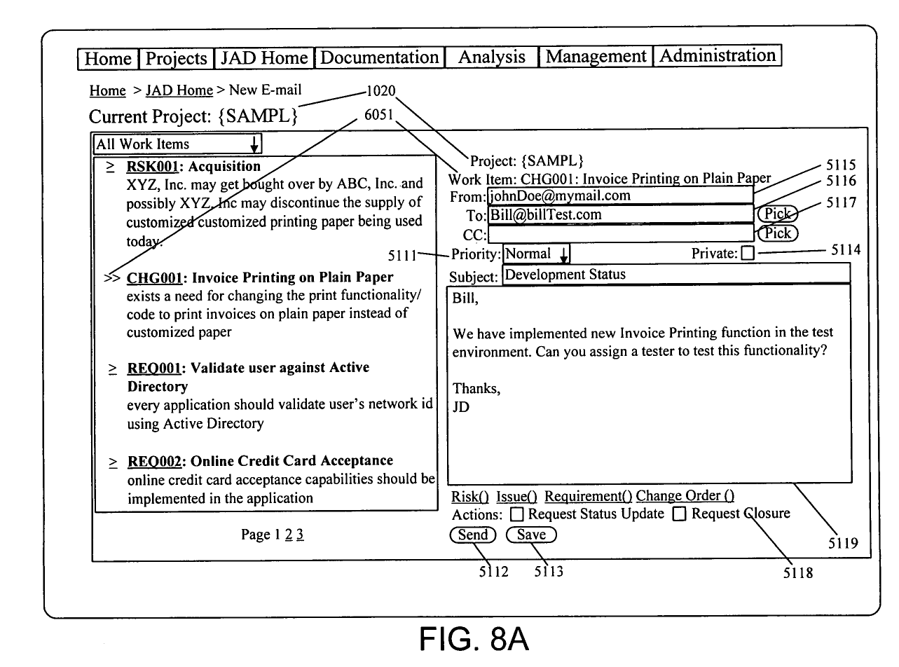

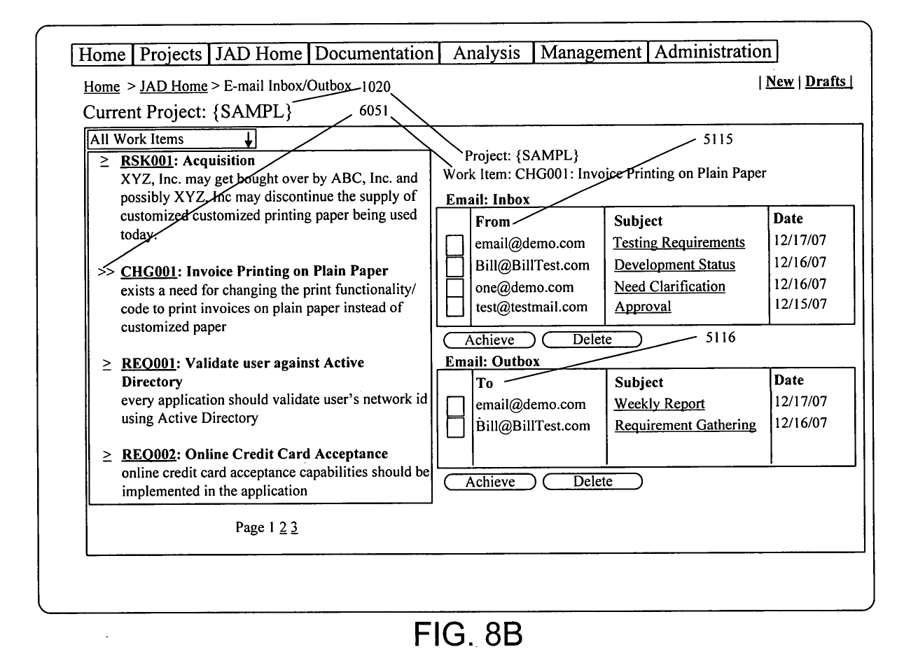

FIGS. 8A and 8B illustrate the added functionality such a system provides when using the system as a email server for project-related communications. FIG. 8A illustrates an interface for composing an email communication. Project abbreviation project 1020 and work item 6051 are provided in the illustrated fields to indicate that the email communication relates to the “SAMPL” project and requirement “REQ001” of the project. Conventional email functions are provided on the send email interface including Priority dropdown 5111 which sets the priority of the e-mail, Send button 5112 which sends the e-mail to recipients 5116 and 5117, and Save button 5113 which saves the draft of an e-mail in electronic storage 8000 but does not sends out the e-mail. From field 5115 is pre-filled based on the user who is logged in, To field 5116 designates the recipient of the e-mail and user may pick the recipients by clicking Pick button and selecting available users from the system. CC field 5117 is to designate the carbon copy recipients of the e-mail communication.

In addition to the conventional email functions, Private or Public dropdown 5114 is further provided to designate whether access to the e-mail communication is to be restricted to sender 5115 and recipients 5116 and 5117 or whether other members of the project team may also view the email communication. If the sender selects value Public from Private or Public dropdown 5114, then the e-mail communication becomes available for every user in the system to view.

Furthermore, the sender can request certain feedback by selecting one of Actions 5118. In the present example, the sender may select “Request Status” or “Request Closure” actions to request that the recipient to update the system on the status of the work item or to “close” a work item which has been completed, respectively. The sender completes the e-mail by entering text in the e-mail body 5119. If the sender selects the “Request Closure” action, the recipient will receive a message indicating that the sender believes that all work on the selected work item has been completed and that the work item should now be closed. The recipient may then select a “Development Complete” action in response e-mail. If this step is taken, the status of the work item 6051 will be changed in the system to reflect that the work item has been completed and closed.

An interface for an email inbox is illustrated in FIG. 8B. The email interface shown in FIG. 8B is configured to display email correspondences as they relate to a particular project and work item. In the present illustration, emails are shown that relate the project represented by project abbreviation 1020 (project “SAMPL”) and work item 6051. The email display panel shows From field 5515, To field 5116, and the Subject field. All e-mails related to the work item, marked as public or addressed to the logged in person are displayed. The user can select other work items listed in the work item panel shown to the left of the email display panel to see email correspondences related to the other work items.

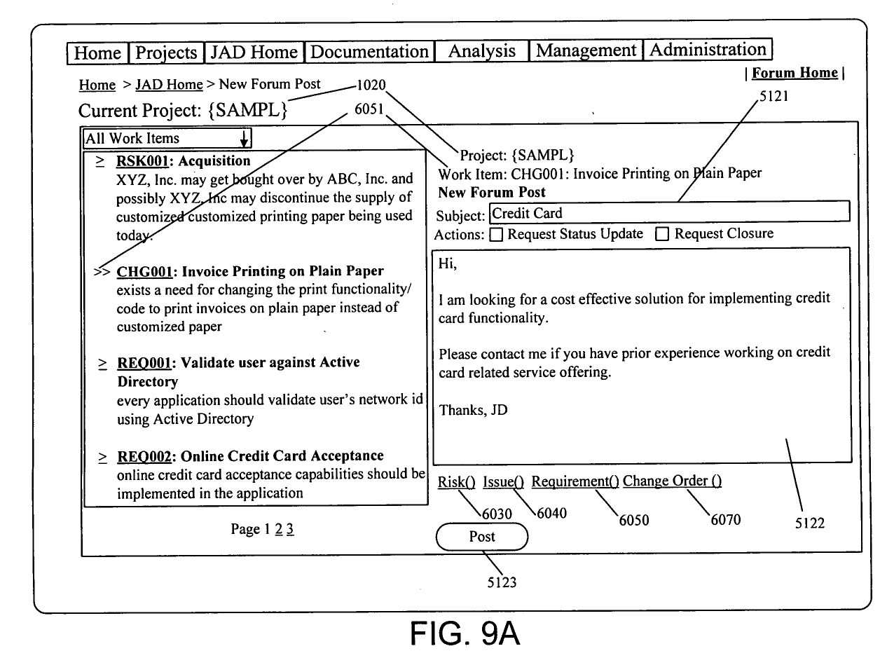

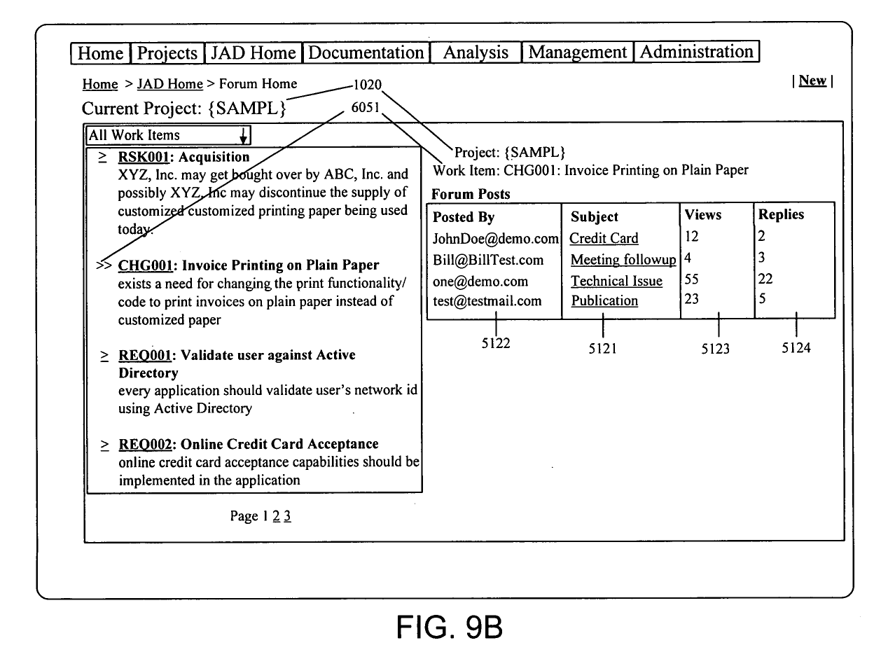

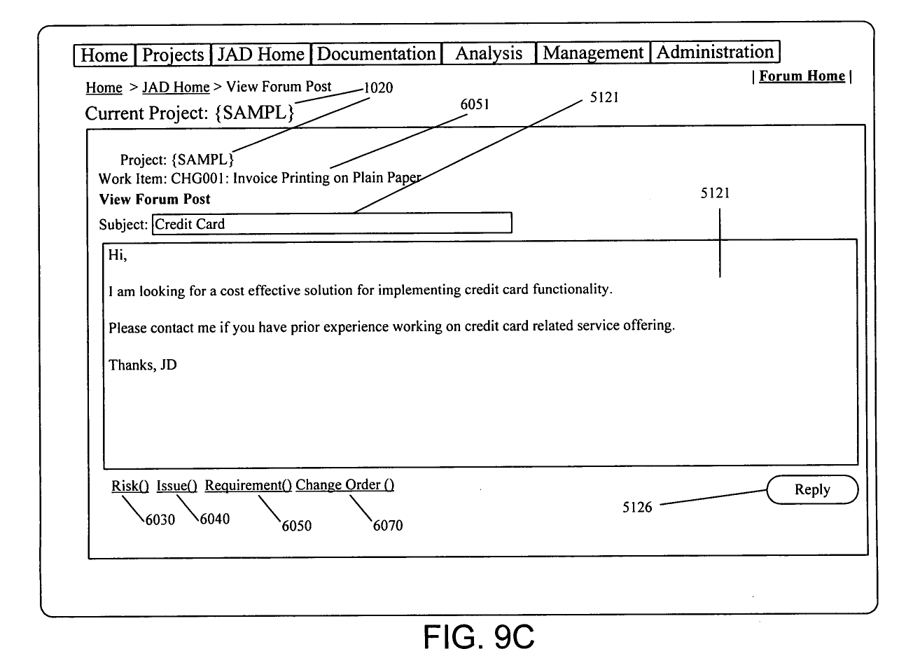

FIG. 9A shows an interface for making a post on an online forum. The forum post made in the present illustration relates to the project referenced by project abbreviation 1020 and work item 6051. The user can specify Subject 5121 and post a message in body 5122. The user selects the Post 5123 button to post the message on the forum. This starts a discussion thread where other subscribers to the online forum, can post responses and discuss related matters. Optionally, while typing the forum post the user may use Risk( ) annotation tool 6030, Issue( ) annotation tool 6040, Requirement( ) annotation tool 6050, or Change Order( ) annotation tool 6070 after selecting a portion of the text in body 5122 to annotate and association the portion of text with an existing work item or to propose a new work item. If proposing a new work item, the system will create a work item in “Proposed” state and maintain the traceability of the work item.

As shown in FIG. 9B, the user interface can show all discussion threads or forum posts that relate to the project referenced by project abbreviation 1020 and work item 6051. The discussion thread display panel shows a summary of each discussion thread or forum post relating to the selected project and work item including Subject field 5121 (which shows the title of the discussion thread), Posted By 5122 (indicated who made the forum post), Views 5123 (indicating how many times the discussion thread had been viewed by a subscriber) and Replies 5124 (indicating how many responses have been posted in reply to the opening post). The user may select other work items shown in the work item display panel (which is situated to the left of discussion thread display panel in the current view)

Upon clicking on one of the subject in Subject field 5121, the system will display the opening post as shown in FIG. 9C. Any valid user can view the form post by clicking on the Subject field 5121, and optionally reply to the forum post by selecting Reply button 5126. Furthermore, when reading the post, the user can also propose new work items by selecting portions of the text and Risk( ) annotation tool 6030, Issue( ) annotation tool 6040, Requirement( ) annotation tool 6050 or Change Order( ) annotation tool 6070.

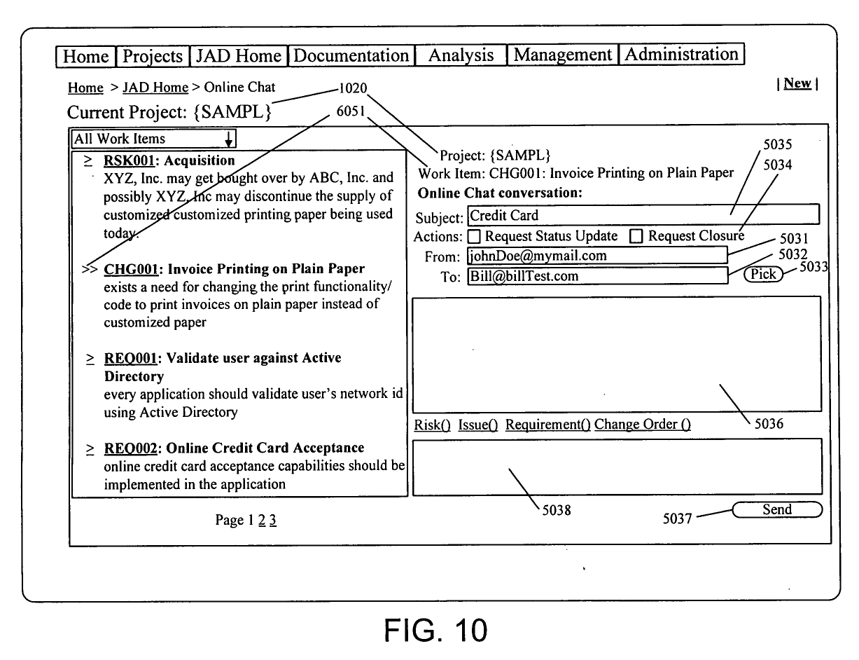

FIG. 10 shows an interface for conducting an online chat conversation with one or more team members. The online chat conversation in the present illustration relates to the project referenced by project abbreviation 1020 and work item 6051. From field 5031 shows the person who originates the chat conversation. To field 5032 shows the other party or parties engaged in the conversation. The user can select Pick button 5033 and select one or more users with whom to chat. The user may request certain actions to be taken by one of the engaged parties using action request 5034. If one of the engaged parties wishes to comply with the action request, system will update the status of work item 6051 accordingly. Subject field 5035 indicates the subject of the conversation. The user can type in the message in body 5038 and click Send button 5037. The system will append the text in the displayed text area panel 5036. Text area panel 5036 shows the accumulative result of the conversations between the participants.

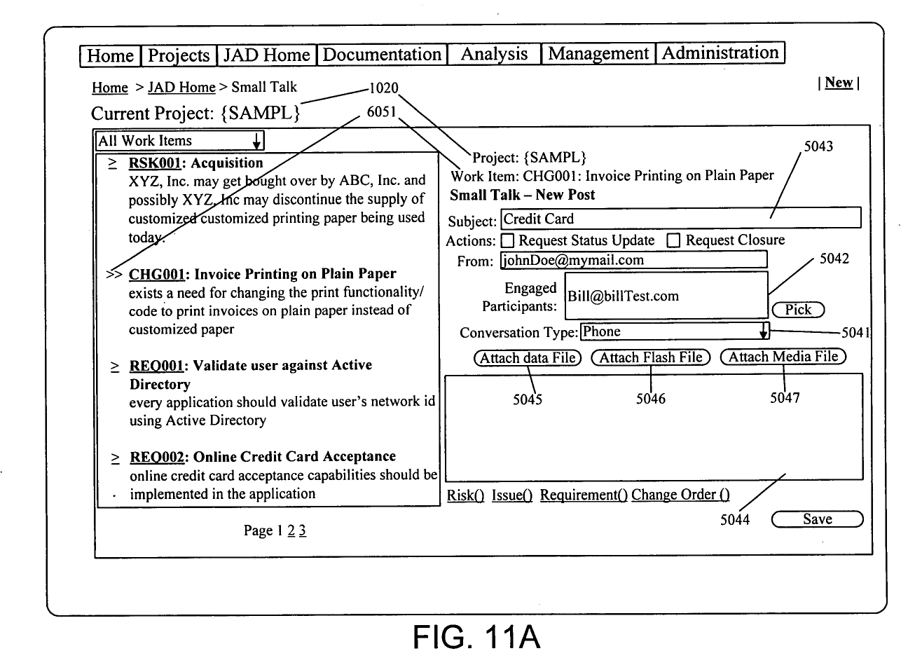

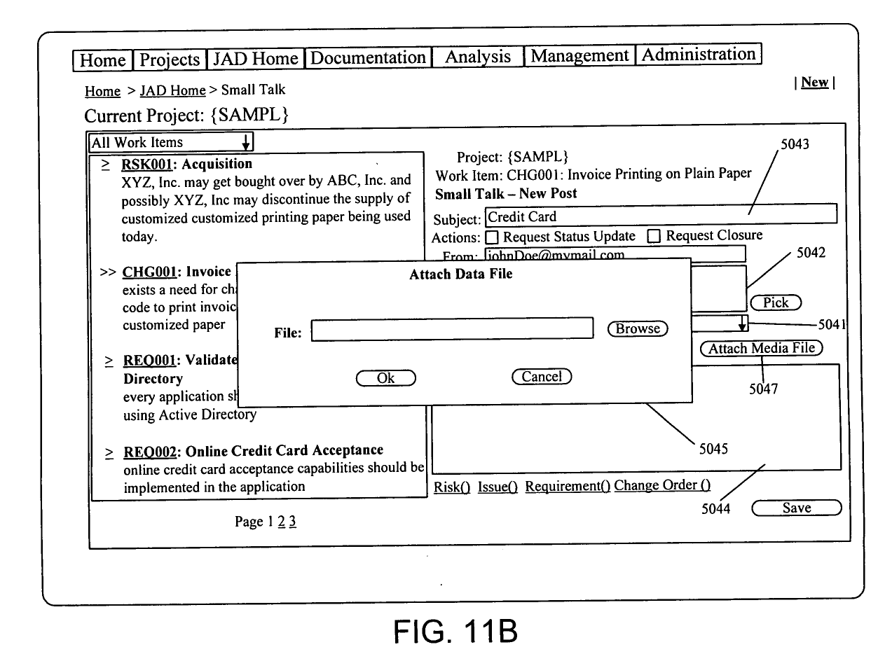

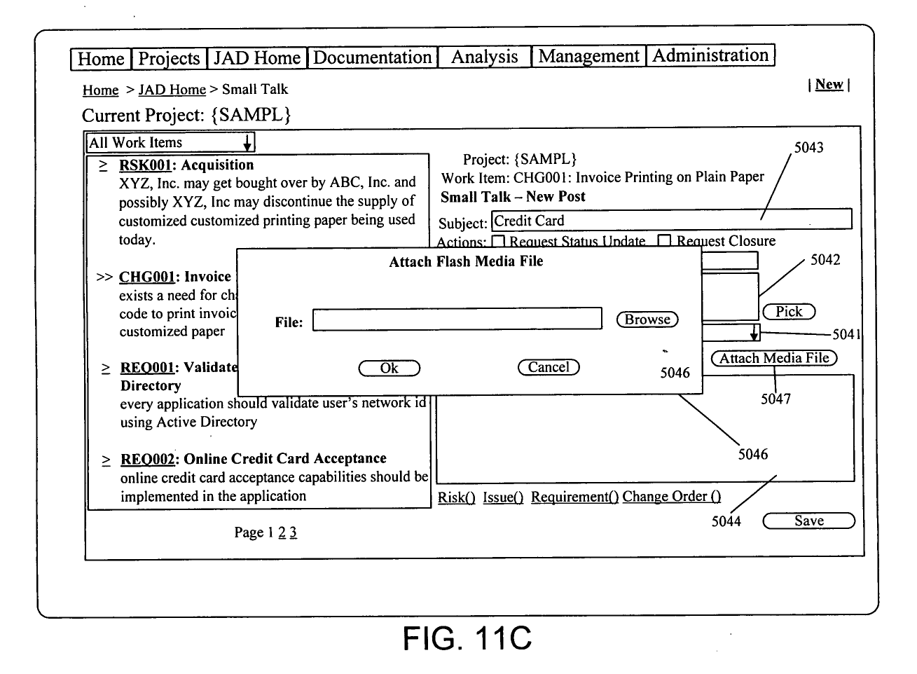

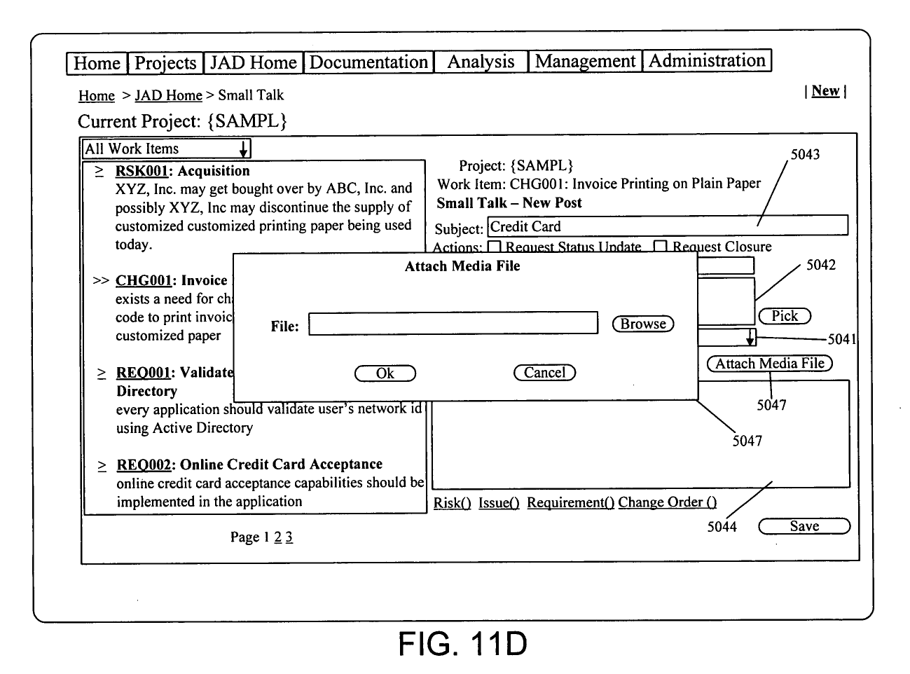

FIGS. 11A-11D illustrate an interface and method for capturing “small talk” communications. “Small talk” communications are miscellaneous communications occur in an informal setting. Various communication media used for capturing small talk conversations can be associated in the system with reference to the project 1020 and selected work item 6051. FIG. 11A illustrates capturing communication in text format. In body field 5044 text of the conversation can be entered in free text format. Conversation type drop-down box 5041 is used to indicate the type of conversation. Conversation type drop-down box 5041 may include such options as “Phone,” “Hallway/Coffee Room,” “Meeting,” and “Other.” Engaged Participants field 5042 indicates the parties involved in the conversation. Subject field 5043 indicates the subject of the conversation. Other electronic files may be attached as part of a captured small talk communication by selecting Attach File link 5045, Flash Media link 5046 and Windows Media link 5047. Optionally, other types of electronic media can also be included as part of the present invention. As described previously, the user may use the various annotation tools to select a portion of text and associate the portion of the text with a particular work item.

FIG. 11B-11D illustrates how an external file may be captured as part of a small talk communication. As shown in FIG. 11B, after selecting File link 5045 (shown in FIG. 11A), popup window 5045 provides the capability for users to select and upload any external file with reference to the selected project abbreviation 1020 and selected work item 6051. As shown in FIG. 11C, after selecting Flash Media link 5046 (shown in FIG. 11A), popup window 5046 provides the capability for users to select and upload any flash media file with reference to the selected project abbreviation 1020 and selected work item 6051. As shown in FIG. 11D, after selecting Windows Media link 5047 (shown in FIG. 11A), popup window 5047 provides the capability for users to select and upload any Windows Media file with reference to the selected project abbreviation 1020 and selected work item 6051.

All users who have been granted access to the selected project can always view any communication under the project portal. Any communication (including e-mail, chat, etc.) that takes place under the project portal will be treated as available to all authorized users to view and participate in the communication whenever appropriate rights allows them to. As per the present invention, communications are presented with reference to a specific project. This provides the significant benefit of allowing users to view all communications relating to work items and view how work items were created and how work items changed states throughout the duration of the project. In order to facilitate the cross-referencing of communications with particular work items, a database-type architecture may be used as described previously with respect to FIG. 1.

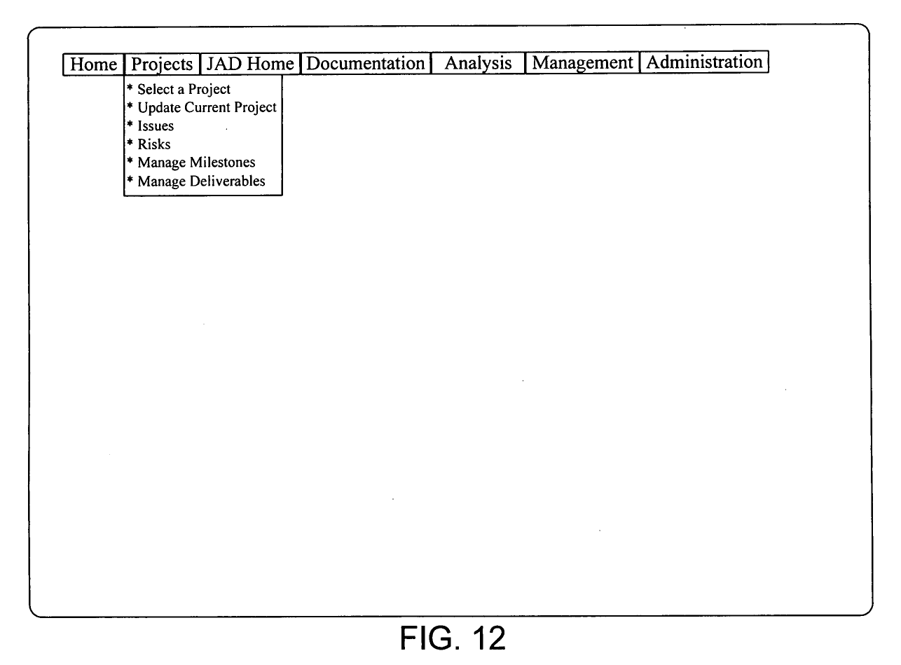

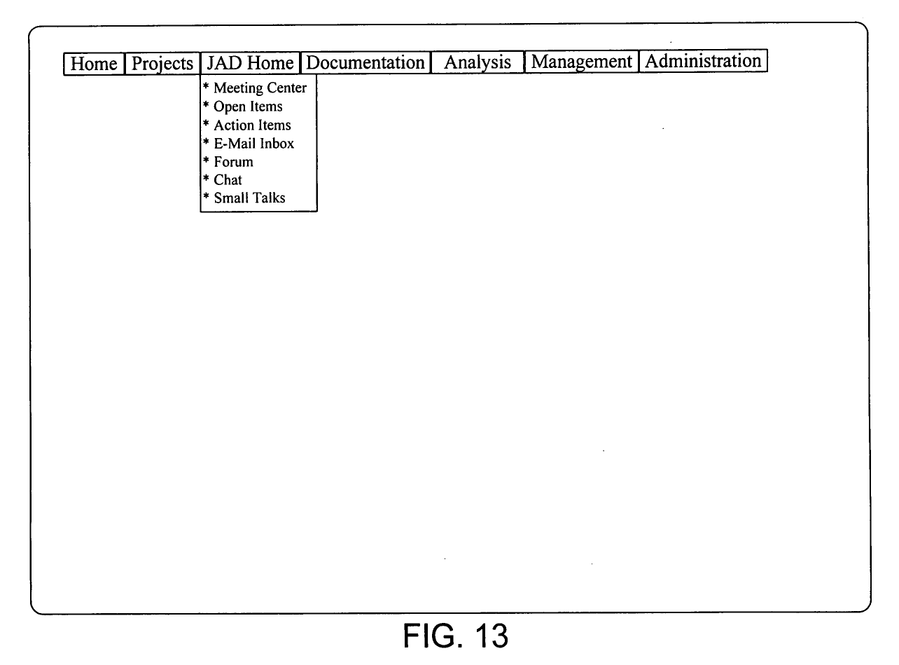

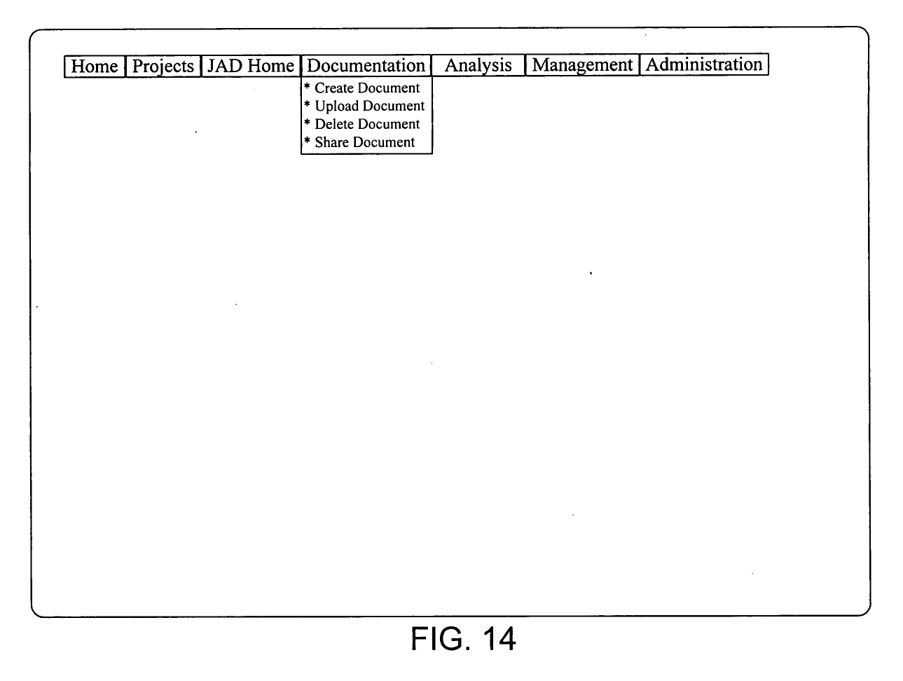

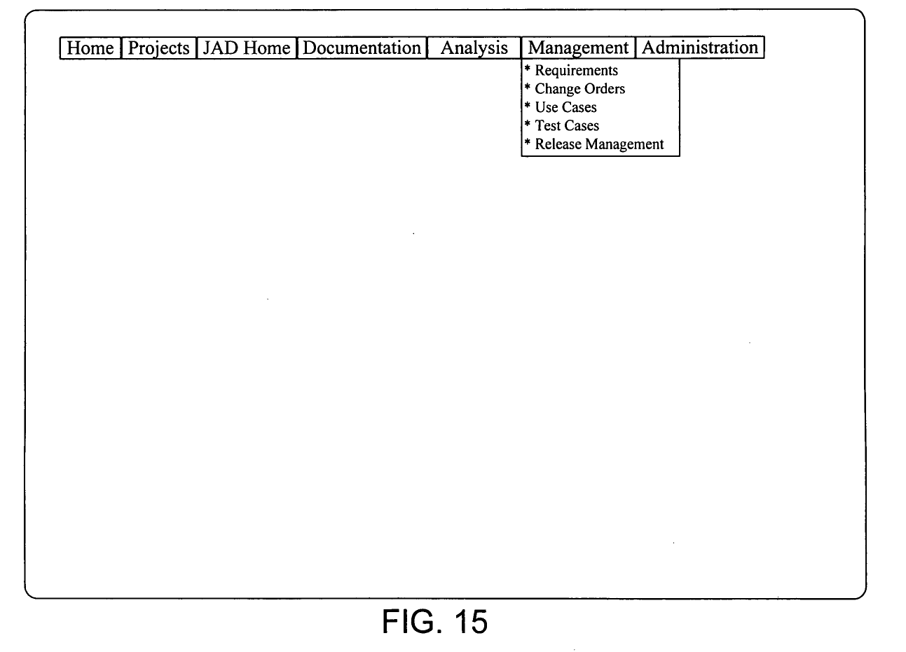

According to one or more embodiments of the present invention, additional processes and methods can be implemented in the integrated, collaborative environment are shown in FIG. 12, FIG. 13, FIG. 14, and FIG. 15.

FIG. 12 illustrates a portion of a menu structure which may be accessed to utilize additional project-related management processes available in the project portal. These processes include Project Issues Management, Project Risk Management, Project Milestone management and Project Deliverables Management tools. In this case project related Issues and Risk workflows can be implemented in the same integrated processes or methods of the current invention. Also, the process or method for tracking and managing Milestones and Deliverables of a project can also be implemented as part of the current invention. As per the present invention, these processes can be optionally customized to suit the need of the project or customer or both.

Various methodologies are practiced generally in project management fields and more particularly in the field of information technology. These methods are generally known to one that is skilled in the art. The present invention provides predefined workflow management and project management processes but optionally allows user to customize these processes as per the needs of the organization. Hence integration of these methodologies is part of the present invention but a more thorough description of these methodologies is omitted herein.

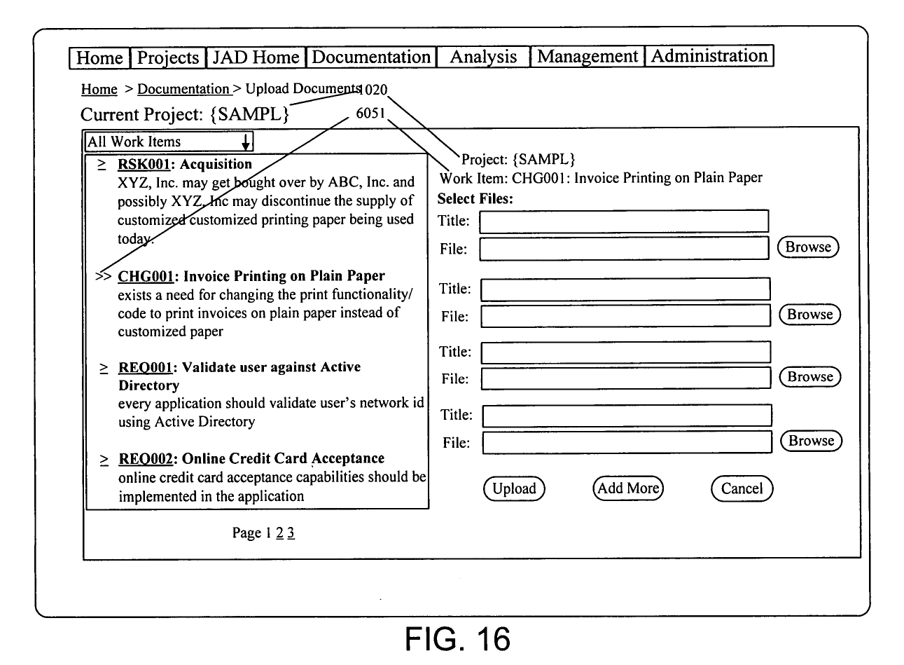

FIG. 13 shows part of a menu structure which may be accessed by a user to access various project-related information interfaces including the interfaces illustrated in FIGS. 5A-11 as they relate to a specific project. FIG. 14 shows part of a menu structure which may be accessed by a user to create, upload, delete and share external documents with reference to the selected project and/or a work item. FIG. 16 is a sample user interface for uploading a document with reference to a selected project and/or work item.

FIG. 15 shows part of a menu structure which may be accessed to manage various work items including “Requirements,” “Change Orders,” “Use Cases,” “Test Cases.” The user may also access a “Release Management” tool. In the context of information technology, “Release Management” involves executing one or more Requirements, and/or one or more Change Requests as one Release of an information technology product. Optionally, these processes can be customized as per the need of a project or an organization.

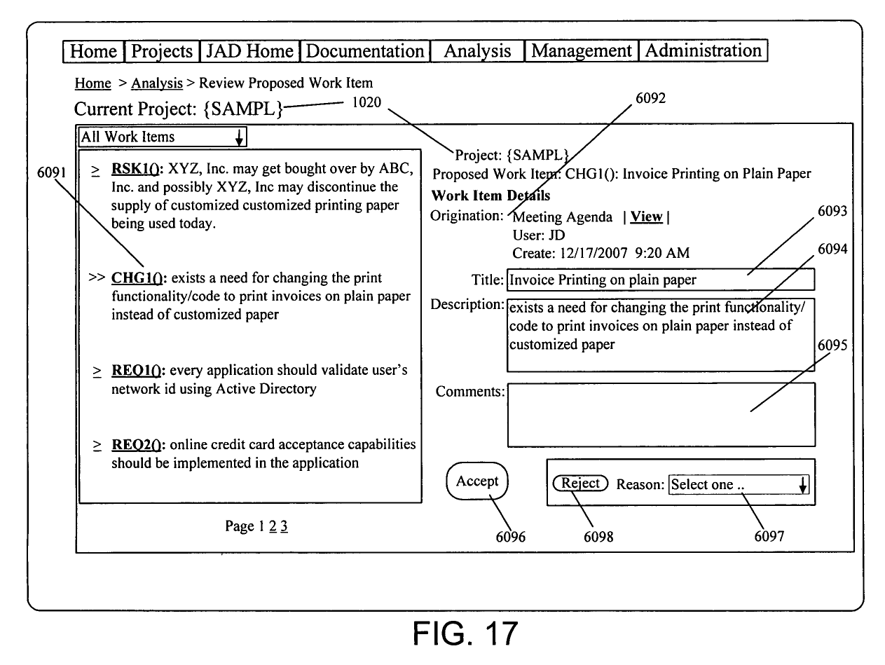

Turning now to FIG. 17, a user interface is illustrated wherein a user (in this case Project Manager or Business Analyst) can review a proposed work item and accept or reject the work item using Accept button 6096 or Reject button 6098, respectively. As described previously, whenever a user marks any work item using Risk( ) annotation tool 6030, Issue( ) annotation tool 6040, Requirement( ) annotation tool 6050 or Change Order( ) annotation tool 6070 the system save the record in the database 8000 with the state “Proposed.” A Project Manager or Business Analyst assigned to the selected project may access the user interface shown in FIG. 17 to accept or reject the work item. In FIG. 17, the proposed work item is shown as an “Open Item” in Work Item Type field 6091. Origination field 6092 indicates the place or communication thread where the work item originated. In the present example, the work item originated from a “Meeting Agenda.” The e-mail of the user originating the work item and the date and time of origination is also included.

Upon selecting a work item, the system populates the Detail Description field 6094 with the selected or “annotated” text of the captured communication originating the work item proposal. The user may modify the description in Detail Description field 6094. The user may input a short name for the work item in Short Heading field 6093 and enter additional comments in comment field 6095. The user may then “accept” the proposed work item by clicking Accept button 6096. Optionally, the user may reject the proposed work item by clicking the Reject button 6098. In the case of rejection, the user provides a reason for rejecting the proposed work item in Reject Reason drop-down box 6097. The system changes the state of the work item internally to “New” or “Rejected” as per the user's action and tracks the user id, date and time of the state change (as shown in FIG. 7 as part of the state change history).

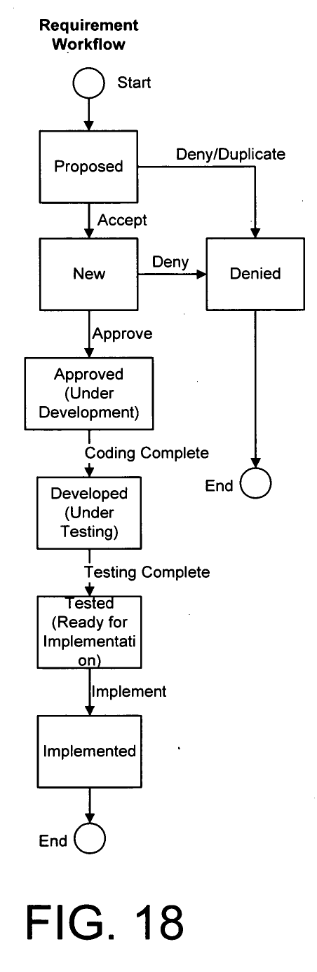

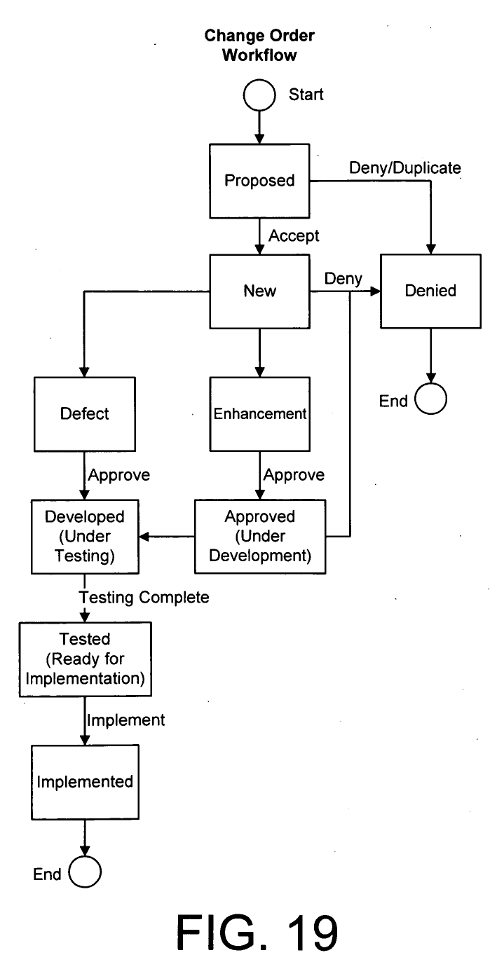

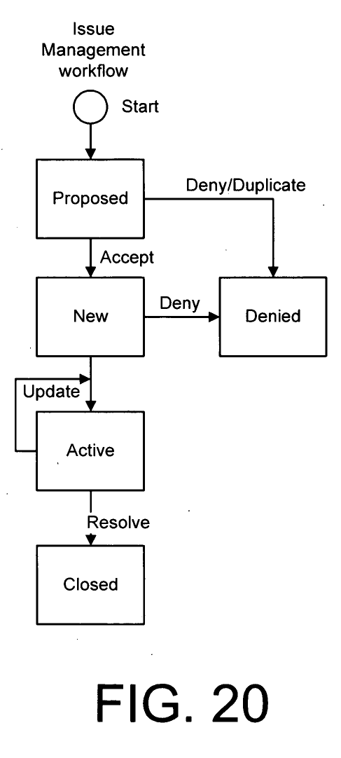

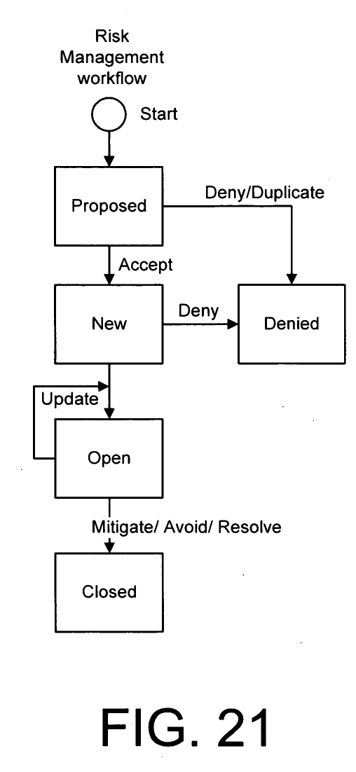

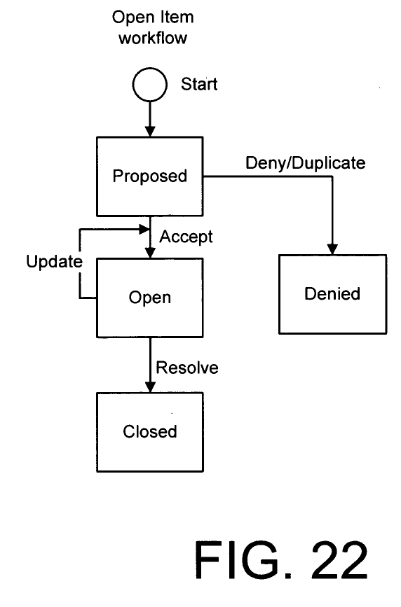

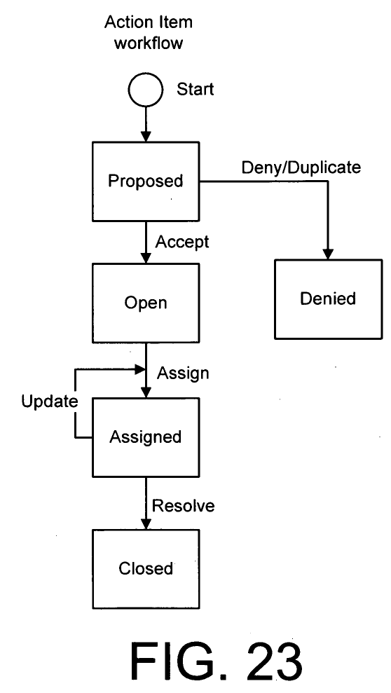

General workflows for the various types of the work items are shown in FIG. 18-FIG. 23. FIG. 18 illustrates workflow for the Requirement type of work item. FIG. 19 illustrates workflow for the Change Order type of work item. FIG. 20 illustrates workflow for the Risk type of work item. FIG. 21 illustrates workflow for the Open Item type of work item. FIG. 22 illustrates workflow for the Open Item type of work item. FIG. 23 illustrates the workflow for the Action type of work item. These workflows are incorporated to demonstrate that such workflows can be integrated as per the one or more embodiments of the present invention. These workflows can be customized and additional types of work items with customized workflows can be added as per the one or more embodiment of the present invention.

As shown in FIG. 14, the system is further configured to automatically populate a Work Breakdown Structure (WBS) of the project plan with “Tasks” when work items are generated. Various prior art project management methodologies including Project Management Body of Knowledge (PMBoK), Agile methodologies (e.g. SCRUM), and Rational Unified Process (RUP) use a WBS to track Tasks with reference to Money, Resources and Time. According to one or more embodiments of the present invention work items generating from the communication can be directly inserted into a chosen work breakdown structure (WBS) as Tasks. Thus, the system may automatically supply or insert Tasks into the project plan.

In the previous description, the present invention is described with reference to the information technology project management. But implementation or usage of the present invention is not limited to the information technology projects. One or more embodiments of the present invention can be applied to project management in other industries and in non-project management fields as well. Although the term “work item” is generally understood by those in project management fields, in other non-project management fields, the term “work item” is any type of task that is regularly performed in the course of business.

As a non-project management example, marketing activities in a large organization typically involve a team of sales staff pursuing various sales leads. Members of the sales team transmit various internal and external communications to facilitate the development of a proposal or responding to prospective customer's needs individually or collectively. Using the method of the present invention, these communications related to the lead can be captured and organized in an integrated way under a “lead” portal. In this form of implementation the “lead” corresponds to the “project” portal as explained earlier. Proposals or a section of the proposal proposals or topics of the communication in broader sense may be considered “work items.”

In another form of implementation of the present invention, communications between members of an organization specializing in scientific or other research can be integrated and organized under the portal—“Research Project.” All communications that relate to a research project can be organized under the Research Project portal. Experiments and other research tasks may be considered “work items.”

The present invention may also be used in legislative fields to track communications relating to legislative bills and topics of proposed legislation. In this example, communications may be organized under a “Bill” portal with the analysis of various “subtopics” of the bill representing “work items.”

Further, in some embodiments it may be preferable to employ the present invention using customized handheld, portable electronic devices which communicate wirelessly with a central server. In these embodiments, the communications are electronically stored on the central server. Each member of the team uses a portable electronic device to create the electronic communications and annotate portions of the electronic communications that relate to the various project work items. The portable electronic device may be specifically configured to facilitate the creation of the various communication types discussed herein. For example, a graphical user interface may be employed on the portable electronic device which allows the user to create an email, make a post on a thread, engage other team members in a textual “chat” type conversation, prepare notes, or engage other team members and clients in a phone conversation. Phone conversations and voice mail may be recorded onto the central server for later reference. While such a handheld portable electronic device may not provide all of the robust options available to a user on a standard computer terminal, such a device would allow a team member to create various types of project-related communications, annotate such communications, and access communications prepared by members of the project team using the previously described project and work item indexing system.

The reader should appreciate the present invention can be implemented using any customizable form. Thus, any business function needing to capture, facilitate and organize communication under a customized portal can be benefited from the present invention.

What is claimed is:

1. A computer-implemented method for coordinating a project to be executed by a first team member and a second team member comprising:
a. digitally capturing a first communication, said first communication prepared by said first team member for the benefit of said second team member;
b. annotating a first portion of said first communication that references a matter of interest to said project with a first annotation;
c. utilizing said first annotation to automatically generate a first work item relevant to the execution of said project, said first work item relating to said matter of interest referenced in said first portion of said first communication; and
d. associating said first portion of said first communication with said first work item such that said communication is linked to said first work item.

2. The computer-implemented method of claim 1, wherein said first communication is a communication selected from a group consisting of:
a. a meeting record;
b. an email;
c. an online chat conversation record;
d. an online forum discussion record;
e. a project report; and
f. a conversation record.

3. The computer-implemented method of claim 1, wherein said first work item is a work item selected from a group consisting of:
a. an action item;
b. an open item;
c. a risk;
d. an issue;
e. a requirement; and.
f. a change order.

4. The computer-implemented method of claim 1, further comprising:
a. automatically populating a work breakdown structure with a task corresponding to said first work item when said first work item is generated;
b. providing a graphical user interface for illustrating said work breakdown structure, said graphical user interface referencing said first work item along with other work items related to said project.

5. The computer implemented method of claim 1, further comprising:
a. recalling a plurality of communications which reference said project and said work item including said first communication; and
b. displaying a list of said plurality of communications which reference said project and said work item on a graphical user interface including said first communication.

6. The computer implemented method of claim 1, further comprising:
a. defining a plurality of work items including said first work item;
b. creating an electronic record of said plurality of work items including an electronic record of said first work item;
c. providing a user interface configured to allow said first team member to select said first work item from said plurality of work items and create said first communication to be viewed by said second member of said project team, said first communication referencing said first work item;
d. creating said first communication; and
e. indexing said first communication such that said first communication is linked to said electronic record of said first work item.

7. The computer implemented method of claim 6, wherein said electronic record of said first work item includes a state indicator, said state indicator indicating a present state of said first work item.

8. A computer-implemented method of coordinating the execution a project by a project team comprising:
a. annotating a communication prepared by a member of said project team to identify a portion of said communication which relates to a first work item to be proposed for consideration;
b. automatically inserting and storing first said work item in a database; and
c. tracking said first work item to indicate changes of state of said first work item as said project team executes said project and said first work item passes through a workflow.

9. The computer-implemented method of claim 8, further comprising tracking communications provoking said changes of state of said first work item.

10. The computer-implemented method of claim 8, wherein said first communication is a communication selected from a group consisting of:
a. a meeting record;
b. an email;
c. an online chat conversation record;
d. an online forum discussion record;
e. a project report; and
f. a conversation record.

11. The computer-implemented method of claim 8, wherein said first work item is a work item selected from a group consisting of:
a. an action item;
b. a requirement; and
c. a change order.

12. The computer-implemented method of claim 8, further comprising:
a. automatically populating a work breakdown structure with a task corresponding to said first work item when said first work item is generated;
b. providing a graphical user interface for illustrating said work breakdown structure, said graphical user interface referencing said first work item along with other work items related to said project.

13. The computer-implemented method of claim 8, further comprising
a. assigning one of a plurality of user roles to each member of said project team; and
b. controlling access rights of each member of said project team based on said user role.

14. The computer implemented method of claim 8, further comprising:
a. defining a plurality of work items including said first work item;
b. creating an electronic record of said plurality of work items including an electronic record of said first work item;
c. providing a user interface configured to allow said member to select said first work item from said plurality of work items and create said communication, said first communication referencing said first work item;
d. creating said first communication; and
e. indexing said first communication such that said communication is linked to said electronic record of said first work item.

15. The computer implemented method of claim 14, wherein said electronic record of said first work item includes a state indicator, said state indicator indicating a present state of said first work item.

16. A method for executing a project comprising:
a. capturing a communication relating to said project in an electronic format;
b. selecting a portion of said communication relating to a potential work item to be executed when executing said project;
c. annotating said portion of said communication to indicate that said portion of said communication relates to said potential work item;
d. automatically generating a first workflow process for changing the state of said potential work item over the course of said project.

17. The method of claim 16, further comprising:
a. selecting a work item category for said potential work item from a plurality of work item categories;
b. providing a plurality of workflow processes including said first workflow process, each of said plurality of workflow processes describing a process for executing work items categorized in one of said work item categories;
c. automatically generating said first workflow process based on said work item category selected.

18. The method of claim 16, wherein said communication is a section of text selected from a group consisting of:
a. a meeting record;
b. an email;
c. an online chat conversation record;
d. an online forum discussion record;
e. a project report; and
f. a conversation record.

19. The method of claim 16, wherein said potential work item is a work item selected from a group consisting of:
a. an action item;
b. an open item;
c. an issue;
d. a risk;
e. a requirement; and
f. a change order.

20. The method of claim 16, further comprising:
a. automatically populating a work breakdown structure with a task corresponding to said potential work item when said first workflow process is generated;
b. providing a graphical user interface for illustrating said work breakdown structure, said graphical user interface referencing said potential work item along with other work items related to said project.

21. The method of claim 16, further comprising:
a. recalling a plurality of communications which reference said project and said work item including said communication; and
b. displaying a list of said plurality of communications which reference said project and said work item on a graphical user interface including said communication.
